(19) United States
(12) Patent Application Publication
(10) Pub. No.: US 2005/0087249 A1
(43) Pub. Date: Apr. 28, 2005

(54) Pure-water pipe for fuel cell

(75) Inventors: Atsushi Izumi, Nabari-shi (JP); Ryoji Manai, Nabari-shi (JP); Kenta Niwa, Nabari-shi (JP); Shoji Shimizu, Nabari-shi (JP); Keisuke Wakabayashi, Yokosuka-shi (JP)

Correspondence Address: DARBY & DARBY P.C., P. O. BOX 5257, NEW YORK, NY, 10150-5257, US

(73) Assignees: Nitta Moore Company, Osaka-shi (JP); Nissan Motor Co., Ltd., Yokohama-shi (JP)

(21) Appl. No.: 10/973,120

(22) Filed: Oct. 25, 2004

(30) Foreign Application Priority Data
Oct. 23, 2003 (JP) 2003-363816

(51) Int. Cl. F16L 11/00

(52) U.S. Cl. 138/121; 138/137; 428/36.91

(57) ABSTRACT

A pure-water pipe for fuel cell has an innermost layer made of fluoro resin or polyolefin resin wherein an entire body of the pipe is made of resin and the pipe has a value of (a total thickness of the pipe)/(a thickness of the innermost layer) in a range of 1.1 to 40. The pure-water pipe further has a layer in the outside of the innermost layer which contains one of polyamide, polyester elastomer and polyolefin elastomer or a layer in the outside of the innermost layer which contains non-plastic polyamide. The pure-water pipe further has a low hydrogen-permeable layer in the outside of the innermost layer. The low hydrogen-permeable layer contains ethylene-vinyl alcohol copolymer, polymethaxyleneadipamide, or polybutylene naphthalate.

### INCORPORATION BY REFERENCE

The present application claims priority under 35 U.S.C. §119 to Japanese Patent Application No. 2003-363816 filed on Oct. 23, 2003. The content of the application is incorporated herein by reference in its entirety.

### BACKGROUND OF THE INVENTION

This invention relates to a pure-water pipe for fuel cell scarcely contaminating pure water flowing therethrough.

Recently, because of environmental problems and petroleum depletion problems, development of fuel cell vehicles has been flourishing.

Metal pipes made of stainless steel (SUS) have been used as a pure-water pipe for fuel cell; however, there have been the following problems. That is, because of being metal pipes, stainless pipes are very heavy and hard, and therefore they neither can absorb vibration and assembly error nor have electric insulation property.

As a pipe for solving all of the above-mentioned problems, those made of rubber are known (Japanese Patent Application Laid-Open No. 2003-73514).

However, in the case of using a pipe made of rubber, ion dissolution from the pipe is significant, and consequently the power generation efficiency of a fuel cell is decreased and the output of the fuel cell is considerably lowered; and furthermore, it is required to enlarge an ion exchange resin filter for removing dissolved ion. Also, if hydrogen is mixed with the fluid in the pipe, the hydrogen is transmitted through the pipe to the outside.

Therefore, an object of the present invention is to provide a pure-water pipe for fuel cell which weighs satisfactorily light, can absorb vibration and assembly error, has an insulating property, and can suppress ion dissolution from itself.

Furthermore, another object of the present invention is to provide a pure-water pipe for fuel cell which weighs satisfactorily light, can absorb vibration and assembly error, has an insulating property, can suppress ion dissolution from itself and can prevent hydrogen transmission to the outside.

### BRIEF SUMMARY OF THE INVENTION

According to the present invention, a pure-water pipe for fuel cell has an innermost layer made of fluoro resin or polyolefin resin wherein an entire body of the pipe is made of resin and the pipe has a value of (a total thickness of the pipe)/(a thickness of the innermost layer) in a range of 1.1 to 40.

The pure-water pipe for fuel cell may have a layer in the outside of the innermost layer which contains polyamide, polyester elastomer or polyolefin elastomer.

The pure-water pipe for fuel cell may have a layer in the outside of the innermost layer which contains non-plastic polyamide.

The pure-water pipe for fuel cell may have a low hydrogen-permeable layer in the outside of the innermost layer.

The low hydrogen-permeable layer of the pure-water pipe for fuel cell may contain ethylene-vinyl alcohol copolymer, polymethaxylyleneadipamide or polybutylene naphthalate.

The body of the pure-water pipe may be partly corrugated.

The pure-water pipe for fuel cell of the present invention weighs satisfactorily light, can absorb vibration and assembly error, has an insulating property and can suppress ion dissolution from itself.

Especially, if the innermost layer of the pure-water pipe for fuel cell has the low hydrogen-permeable layer, preferably containing ethylene-vinyl alcohol copolymer, polymethaxylyleneadipamide, or polybutylene naphthalate, the pure-water pipe can suppress ion dissolution from itself more efficiently and can prevent hydrogen transmission to the outside.

### DETAILED DESCRIPTION OF THE INVENTION

A pure-water pipe for fuel cell according to the present invention has, basically, an innermost layer containing fluoro resin or polyolefin resin and a layer containing polyamide, polyester elastomer, or polyolefin elastomer in the outside of the innermost layer. The pipe has a value defined as (the total thickness of the pipe)/(the thickness of the innermost layer of fluoro resin or polyolefin resin) in a range of 1.1 to 40.

Examples of the above-mentioned fluoro resin are, but not limited to, polyvinylidene fluoride resin (PVDF), ethylene-tetrafluoroethylene copolymer resin (ETFE), polyvinyl fluoride resin (PVF), ethylene-chlorotrifluoroethylene copolymer (E-CTFE), polychlorotrifluoroethylene resin (PCTFE), tetrafluoroethylene-hexafluoropropylene copolymer resin (FEP), tetrafluoroethylene-perfluoroalkoxyethylene copolymer resin (PFE), and tetrafluoroethylene-hexafluoropropylene-perfluoroalkoxyethylene copolymer resin (FPA). Further, in order to provide adhesive property, these fluoro resins may be modified by introducing functional groups. The functional groups to be introduced can be groups having reactivity and polarity, and preferable examples are, but not limited to, carboxyl, a residual group obtained by dehydration condensation of two carboxyl groups in a molecule, epoxy group, hydroxyl, isocyanato group, ester group, amido group, aldehyde group, amino group, hydrolysable silyl group, cyano group, double bonded carbon-carbon, sulfonic acid group, and ether group.

In terms of cost and molding stability for co-extrusion, a polyvinylidene fluoride resin (PVDF), an ethylene-tetrafluoroethylene copolymer resin (ETFE), and their modified resins, formed by introducing the above functional groups are more preferable.

As the above-mentioned polyolefin resin, olefins having 2 to 6 carbon atoms, preferably 2 to 4 carbon atoms, for example, ethylene, propylene, butylene, and the like are more preferable. They may be homopolymers, their blends or copolymers, and the types of the copolymers are not limited.

Examples of the above-mentioned polyamide resin are PA6, PA66, PA610, PA612, PA11, PA12, and in order to provide flexibility, proper amounts of a plasticizer, an elastomer, and a nylon monomer may be added. Furthermore, in order to lower the contamination of the fluid in the pipe, those which do not or scarcely contain a plasticizer are more preferable.

Examples of the above-mentioned polyester elastomer may be elastomers including as hard segments, crystalline polyesters such as polybutylene terephthalate (PBT) and polybutylene naphthalate (PBN), and as soft segments, polyethers such as polyethylene glycol, polypropylene glycol, polytetramethylene glycol, polyhexamethylene glycol, and the like, adipic acid ester such as ethylene adipate, and the like, and polyesters such as polycaprolactone, polyvalerolactone, aliphatic polycarbonate and the like. Typically, in terms of stability of physical properties from a low temperature to a high temperature, processibility, and flexibility, a polyester-ether block copolymer elastomer having a polyether as a soft segment is preferably used. The above-mentioned polyether is preferably polytetramethylene glycol. Additionally, due to the same reason, a polyester-ester copolymer elastomer having a polyester as a soft segment is more preferably used. The above-mentioned polyester is preferably polycaprolactone.

For the olefin elastomer, various type elastomers containing rubber components and thermoplastic synthetic resin components in proper composition ratios are made available in the markets. Examples of the elastomer may include amorphous random elastic copolymers containing olefins as main components such as ethylene-propylene copolymer rubber, ethylene-propylene-non-conjugated diene type rubber, ethylene-butene-non-conjugated diene type rubber, and propylene-butadiene copolymer rubber.

Since neither a kneading process nor a vulcanizing process, both of are which complicated and add additional steps to the work environments, is required in the production process, and the production cost including saving of the production steps can be lowered, compositions having thermoplastic polyolefin resins and at least partially cross-linked, preferably highly cross-linked EPDM can be exemplified. With respect to the olefin elastomers, as the thermoplastic polyolefin resin, polyethylene, polypropylene, and poly-1-pentne can be exemplified, and polyethylene and polypropylene are preferable, especially polypropylene. The olefin elastomers may contain, as appropriate, a variety of additives such as a plasticizer, a filler, a stabilizer, a lubricant, a coloring agent, a flame retardant, and resin.

### EXAMPLE 1

As shown in Table 1, the pure-water pipe for fuel cell has a 12.7 mm outer diameter, a 9.56 mm inner diameter, a wall thickness at 1.57 mm, and a 1,000 mm pipe length. Further, the pure-water pipe has a three-layer structure composed of a first innermost layer, containing HDPE (high density polyethylene) with 0.2 mm thickness; a second layer containing modified PP (modified polypropylene) with 0.2 mm thickness; and a third outermost layer, containing PA12 (polyaminde 12) with 1.17 mm thickness. Accordingly, as shown in Table 1, this pipe has a value of 7.85 calculated as (the total thickness of the pipe)/(the thickness of the innermost layer).

TABLE 1

| | | | Ex.1 | Ex.2 | Ex.3 | Ex.4 | Ex.5 | Ex.6 |
|---|---|---|---|---|---|---|---|---|
| tubing | external diameter (mm) | | 12.7 | 12.7 | 6 | 33.4 | 10 | 12.7 |
| size | internal diameter (mm) | | 9.56 | 9.56 | 4 | 25.4 | 8 | 9.56 |
| | length (mm) | | 1000 | 1000 | 500 | 500 | 500 | 1000 |
| wall | wall thickness | | 1.57 | 1.57 | 1 | 4 | 1 | 1.57 |
| structure | innermost | material of | HDPE | HDPE | HDPE | HDPE | HDPE | PVDF |
| | | 1^{st} layer | | | | | | |
| | | thickness of | 0.2 | 0.75 | 0.8 | 0.1 | 0.1 | 0.17 |
| | | 1^{st} layer (mm) | | | | | | |
| | | material of | modified | modified | modified | modified | modified | modified |
| | | 2^{nd} layer | PP | PP | PP | PP | PP | PA |
| | | thickness of | 0.2 | 0.1 | 0.1 | 0.1 | 0.1 | 0.2 |
| | | 2^{nd} layer (mm) | | | | | | |
| | | material of | PA12 | PA12 | non plastic | PA12 | TPO | PA12 |
| | | 3^{rd} layer | | | PA12 | | | |
| | | thickness of | 1.17 | 0.72 | 0.1 | 3.8 | 0.8 | 1.2 |
| | | 3^{rd} layer (mm) | | | | | | |
| | | material of | | | | | | |
| | | 4^{th} layer | | | | | | |
| | outermost | thickness of | | | | | | |
| | | 4^{th} layer (mm) | | | | | | |
| | total thickness/thickness | | 7.85 | 2.09 | 1.25 | 40.00 | 10.00 | 9.24 |
| | of the 1^{st} layer | | | | | | | |
| | conductivity | 0-7 | 8.55 | 4.73 | 10.12 | 10.31 | 10.89 | 8.44 |
| | increase value | | | | | | | |
| | (μS/cm) | | | | | | | |
| | per day | 0-7 | 1.22 | 0.68 | 1.45 | 1.47 | 1.56 | 1.21 |
| | convention | 0-7 | 2.04 | 1.13 | 1.01 | 6.55 | 2.18 | 2.02 |
| | value calculated | | | | | | | |
| | as the formula 1 | | | | | | | |
| | per day | 0-7 | 0.29 | 0.16 | 0.14 | 0.94 | 0.31 | 0.29 |
| | | | Ex.7 | Ex.8 | Ex.9 | Ex.10 | Ex.11 | Ex.12 |
| tubing | external diameter (mm) | | 17 | 8 | 26 | 12 | 20 | 6.2 |
| size | internal diameter (mm) | | 14 | 6 | 22 | 10 | 17 | 4 |
| | length (mm) | | 500 | 500 | 500 | 500 | 500 | 500 |
| wall | wall thickness | | 1.5 | 1 | 2 | 1 | 1.5 | 1.1 |
| structure | innermost | material of | PVDF | PVDF | PVDF | ETFE | modified | HDPE |
| | | 1^{st} layer | | | | | ETFE | |
| | | thickness of | 0.2 | 0.1 | 0.1 | 0.15 | 0.2 | 1 |
| | | 1^{st} layer (mm) | | | | | | |
| | | material of | modified | modified | modified | modified | modified | modified |
| | | 2^{nd} layer | PA | PA | PA | ETFE | PA | PP |
| | | thickness of | 0.1 | 0.1 | 0.1 | 0.1 | 0.1 | 0.05 |
| | | 2^{nd} layer (mm) | | | | | | |
| | | material of | PA12 | non plastic | PA12 | modified | polyester/ | TPO |
| | | 3^{rd} layer | | PA12 | | PO | PA alloy | |
| | | thickness of | 1.2 | 0.8 | 1.8 | 0.1 | 0.1 | 0.05 |
| | | 3^{rd} layer (mm) | | | | | | |
| | | material of | | | | TPO | TPEE | |
| | | 4^{th} layer | | | | | | |
| | outermost | thickness of | | | | 0.65 | 1 | |
| | | 4^{th} layer (mm) | | | | | | |
| | total thickness/thickness | | 7.50 | 10.00 | 20.00 | 6.67 | 7.50 | 1.10 |
| | of the 1^{st} layer | | | | | | | |
| | conductivity | 0-7 | 5.23 | 14.57 | 7.86 | 7.73 | 4.93 | 7.52 |
| | increase value | | | | | | | |
| | (μS/cm) | | | | | | | |
| | per day | 0-7 | 0.75 | 2.08 | 1.12 | 1.10 | 0.70 | 1.07 |
| | convention | 0-7 | 1.83 | 2.19 | 4.32 | 1.93 | 2.10 | 0.75 |
| | value calculated | | | | | | | |
| | as the formula 1 | | | | | | | |
| | per day | 0-7 | 0.26 | 0.31 | 0.62 | 0.28 | 0.30 | 0.11 |

[Formula 1]

| | |
|---|---|
| (a convention value) | = (a measured value × a pipe capacity)/(a water contact surface area) |
| | = (a measured value) × x πr²L/2πrL |
| | = (a measured value) × r/2. |

r: the radius of the pipe inside [cm],
L: the pipe length [cm]

Pure water was hermetically stored in the pipe and subjected to a conductivity measurement test after it was left in an oven at 85° C. for 168 hours (one week), taken out of the oven and was cooled down to a room temperature (23±2° C.). As a result, the conductivity increase value of the pipe in one week was 8.55 μS/cm, and thus the conductivity increase value per day was 1.22 μS/cm.

The above-mentioned conductivity increase value was measured in the experiment. A conversion value independent from the pipe diameter was calculated as (the measured value)×(the pipe capacity)/(the water contact surface area)=(the measured value)×πr²L/2πrL=(the measured value)×r/2 (r is the inner radius of the pipe, and L is the pipe length [both in cm]). As a result, the conversion value of the conductivity increase of the pipe was 2.04 in one week and 0.29 per day. If the conversion value of the conductivity increase per day is 1.0 or lower, the pipe can be used as a pure-water pipe for fuel cell.

Therefore, the pure-water pipe for fuel cell does not deteriorate the power generation efficiency of a fuel cell and does not decrease the output of the fuel cell in a short time when in use, so it enables a filter for ion removal to be compact and prolongs the life of the filter.

Further, since an entire body of the pure-water pipe for fuel cell is made of resins, the pure-water pipe is lightweight, can absorb vibration and assembly error and has an insulating property.

### EXAMPLE 2

As shown in Table 1, the pure-water pipe for fuel cell has a 12.7 mm outer diameter, a 9.56 mm inner diameter, a 1.57 mm total thickness, and a 1,000 mm pipe length and has a three-layer structure composed of a first innermost layer, containing HDPE (high density polyethylene) with 0.75 mm thickness; a second layer containing modified PP (modified polypropylene) with 0.1 mm thickness; and a third outermost layer, containing PA12 (polyaminde 12) with 0.72 mm thickness. Accordingly, as shown in Table 1, this pipe has a value of 2.09 calculated as (the total thickness of the pipe)/(the thickness of the innermost layer).

The conversion value of the conductivity increase of the pipe per day was 0.16.

Therefore, the Example 2 pure-water pipe for fuel cell deteriorates the power generation efficiency of a fuel cell and decreases the output of the fuel cell less than when the pipe of Example 1 is in use.

Further, since an entire body of the pure-water pipe for fuel cell is made of resins as the one of the pipe of Example 1 is, the pure-water pipe is lightweight, can absorb vibration and assembly error and has an insulating property.

### EXAMPLE 3

As shown in Table 1, the pure-water pipe for fuel cell has a 6 mm outer diameter, a 4 mm inner diameter, a 1 mm total thickness, and a 500 mm pipe length and has a three-layer structure composed of a first innermost layer, containing HDPE (high density polyethylene) with 0.8 mm thickness; a second layer containing modified PP (modified polypropylene) with 0.1 mm thickness; and a third outermost layer, containing non-plastic PA12 (non-plastic polyaminde 12) with 0.1 mm thickness. Accordingly, as shown in Table 1, this pipe has a value of 1.25 calculated as (the total thickness of the pipe)/(the thickness of the innermost layer).

The conversion value of the conductivity increase of the pipe per day was 0.14.

Therefore, the pure-water pipe for fuel cell also has excellent effects same as the pure-water pipes for fuel cell of Examples 1 and 2.

### EXAMPLES 4 TO 12

As shown in Table 1, these pure-water pipes for fuel cell all have 1.0 or lower conductivity increase value per day although their outer diameters, inner diameters, total thickness values, and materials are different. Therefore, it is apparent that these pure-water pipes for fuel cell also have excellent effects same as the pure-water pipes for fuel cell of Examples 1 to 3.

Among the resins composing the layers described in Table 1, EVOH stands for ethylene-vinyl alcohol copolymer; MXD6 for polymethaxylyleneadipamide; PBN for polybutylene naphthalate; HDPE for high density polyethylene; PA12 for polyamide 12; TPO for olefin type thermoplastic elastomer; PVDF for polyvinylidene fluoride; ETFE for ethylene-tetrafluoroethylene copolymer; PO for polyolefin; TPEE for thermoplastic polyester elastomer; and PP for polypropylene.

Table 2 shows a graph having the axis of abscissas as the value calculated by (the total thickness of the pipe)/(the innermost layer thickness) and the axis of ordinates as the conversion value of the conductivity increase value per day, and in Table 2, Examples 2 and 3 belong to A; Examples 1, 5, 6, 7, 8, 10, 11, and 12 belong to B; Example 9 belongs to C; and Example 4 belongs to D.

TABLE 2

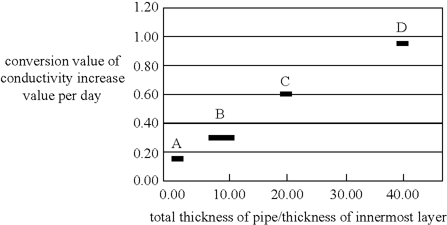

It can be understood that as long as the entire body of the pipe is made of resins and the value defined as (the total thickness of the pipe)/(the thickness of the innermost layer of fluoro resin or polyolefin resin) is in a range of 1.1 to 40, the above-mentioned effects can be obtained.

With respect to Examples 1 to 12, a low hydrogen-permeable layer containing ethylene-vinyl alcohol copolymer, polymethaxylyleneadipamide, polybutylene naphthalate or the like may be formed in the outside of the innermost layer, so even if hydrogen is mixed in water in the pipe, the hydrogen is not transmitted through the pipe to the outside. Accordingly, the hydrogen leakage can be avoided, when the pipe is used for a vehicle and the like.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the sprit and scope of the present invention as defined by the appended claims.

1. A pure-water pipe for fuel cell comprising:
an innermost layer made of one of fluoro resin and polyolefin resin wherein an entire body of the pipe is made of resin and the pipe has a value of (a total thickness of the pipe)/(a thickness of the innermost layer) in a range of 1.1 to 40.

2. The pure-water pipe for fuel cell according to claim 1, further comprising a layer in the outside of the innermost layer which contains one of polyamide, polyester elastomer and polyolefin elastomer.

3. The pure-water pipe for fuel cell according to claim 1, further comprising a layer in the outside of the innermost layer which contains non-plastic polyamide.

4. The pure-water pipe for fuel cell according to claim 1, further comprising a low hydrogen-permeable layer in the outside of the innermost layer.

5. The pure-water pipe for fuel cell according to claim 2, further comprising a low hydrogen-permeable layer in the outside of the innermost layer.

6. The pure-water pipe for fuel cell according to claim 3, further comprising a low hydrogen-permeable layer in the outside of the innermost layer.

7. The pure-water pipe for fuel cell according to claim 4, wherein the polymethaxylyleneadipamide and polybutylene naphthalate.

8. The pure-water pipe for fuel cell according to claim 5, wherein the innermost layer contains one of ethylene-vinyl alcohol copolymer, polymethaxylyleneadipamide and polybutylene naphthalate.

9. The pure-water pipe for fuel cell according to claim 6, wherein the innermost layer contains one of ethylene-vinyl alcohol copolymer, polymethaxylyleneadipamide and polybutylene naphthalate.

10. The pure-water pipe for fuel cell according to claim 1, wherein the body of the pipe is partly corrugated.

11. The pure-water pipe for fuel cell according to claim 2, wherein the body of the pipe is partly corrugated.

12. The pure-water pipe for fuel cell according to claim 3, wherein the body of the pipe is partly corrugated.

13. The pure-water pipe for fuel cell according to claim 4, wherein the body of the pipe is partly corrugated.

14. The pure-water pipe for fuel cell according to claim 5, wherein the body of the pipe is partly corrugated.

15. The pure-water pipe for fuel cell according to claim 6, wherein the body of the pipe is partly corrugated.

16. The pure-water pipe for fuel cell according to claim 7, wherein the body of the pipe is partly corrugated.

17. The pure-water pipe for fuel cell according to claim 8, wherein the body of the pipe is partly corrugated.

18. The pure-water pipe for fuel cell according to claim 9, wherein the body of the pipe is partly corrugated.
